(19) United States
(12) Patent Application Publication
(10) Pub. No.: US 2018/0151938 A1
(43) Pub. Date: May 31, 2018

(54) EASYLY DEPLOYABLE PHASED ANTENNA FOR A SPACECRAFT AND SYSTEM OF SUCH ANTENNAS

(71) Applicant: VILNIUS UNIVERSITY, Vilnius (LT)

(72) Inventors: Saulius RUDYS, Vilnius (LT); Juras BANYS, Vilnius (LT)

(21) Appl. No.: 15/570,506

(22) PCT Filed: Apr. 29, 2016
(86) PCT No.: PCT/IB2016/052438

§ 371 Date: Oct. 30, 2017

(30) Foreign Application Priority Data
Apr. 30, 2015 (LT) 2015 034

(51) Int. Cl. H01Q 1/12; H01Q 21/12; H01Q 1/28; H01Q 19/04; H01Q 3/26

(52) U.S. Cl. CPC H01Q 1/1235; H01Q 21/12; H01Q 3/26; H01Q 19/04; H01Q 1/288

(57) ABSTRACT

An antenna is made from strips of a shape-memory alloy or other resilient material acting as a spring with attached branches that constitute individual monopole antennas. In the folded state, the antenna looks like a strip roll and can be placed on a satellite. When in orbit, the antenna unfolds after the roll retention mechanism is released and orderly unfolds unrolling from a support frame or otherwise extends. The proposed design of monopole branches utilizes conductors of minimum length and achieves maximum directivity. Each monopole branch is connected to the signal receiver/transmitter by signal conduit elements. A system may include at least two such unfolding antennas thus achieving even greater operational effectiveness in regard to signal steerability, interference suppression and reduced moment of the satellite inertia. To prevent problems, additional measures are used that prevent unwinding of inner layers of the roll before the outer layer is extended.

### FIELD OF THE INVENTION

This invention relates to deployable spacecraft antennas, and more specifically with phased array deployable antennas and their systems, which can be packed into a small volume of nanosatellites.

### BACKGROUND OF THE INVENTION

Recently, miniaturized satellites, such as Cube-sat nanosatellites, are increasingly widely used. The dimensions of a single nanosatellite module according to this standard are 10 cm×10 cm×10 cm. Larger satellites can also be built out of these modules. A single module normally consists of various structural elements, such as reflectors, transceivers, antennas, sensors, etc. In spite of the small dimensions, the nanosatellites are used for various tasks. Some of them require directional and steerable beam in VHF and UHF bands, as is the case when tracking ships (AIS systems), aircraft (ADS-B), and radio beacons (Argos) from space. As a rule, nanosatellites are equipped with deployable single-strip monopoly antennas (Encinas Plaza, José, Vilan J. A., Vilén, Aguado, F. Agelet, J., Barandiarán Mancheño, López Estevez, M., Martinez Fernandez, C., Sarmiento Ares, F. “Xatcobeo: Small Mechanisms for CubeSat Satellites-Antenna and Solar Array Deployment,” Proceedings of the 40th Aerospace Mechanisms Symposium, (2010), 415-430) and usually several antennas are mounted on a single satellite. When operating from a low orbit, e.g. at 700 km altitude, the field of view of a conventional non-directional satellite antenna is a circle of 5000 km diameter. The zone can contain a large multitude of devices and the signals from them will overlap in time and interfere with each other. A directional beam would reduce the field of view and likelihood of mutual interference between signals. It would also amplify the signal at the receiver. However, formation of directional and steerable radio beam in VHF and UHF bands requires a large antenna, many times exceeding the standard nanosatellite dimensions. For this reason, antennas capable of generating directional and steerable radio beams are not yet used in the current nanosatellite missions.

The U.S. patent application Ser. No. 07/902,107 disclosed a spacecraft antenna, which is a self-deploying monopoly vibrator system. The major disadvantage of this antenna design is the need for additional guiding structures and a broad transverse plane, on which the monopoly vibrators are mounted. For this reason, the antenna cannot be placed and deployed on a nanosatellite due to its structure and weight. European patent application EP20130003752 disclosed a deployable nanosatellite antenna of helical structure for UHF and VHF bands. This design allows placement of a deployable antenna in a standard-sized nanosatellite, which in the extended configuration is larger than the satellite itself or a standard type monopole nanosatellite antenna. Thus the signal is amplified, yet the direction of the radio beam cannot be changed without turning the antenna itself.

This invention seeks to circumvent the said limitations of nanosatellite antennas by proposing a phased array antenna of deployable construction made of many monopole electric vibrators that could be placed in a standard-sized nanosatellite and deployed from it. The invention makes it possible to place phased array antennas into a small satellite and to take advantage of this type of antennas, such as ability to steer the beam, simultaneous generation of several beams, amplification of desirable signals and suppression of undesirable signals.

### BRIEF DESCRIPTION OF THE INVENTION

The proposed deployable phased array antenna can be made from a strip of lightweight shape memory electrically conductive alloy or another lightweight resilient electrically conductive material that is capable to fully extend after deformation and that includes strip branches forming distinct monopole or dipole electric vibrators. In the folded state, the antenna looks like a strip roll and can be placed on a satellite. When in orbit, the antenna automatically unfolds after the roll retention mechanism is released and orderly unfolds unrolling from a support frame or otherwise extends. The proposed design of the monopole branches utilizes conductors of minimum length and achieves maximum directivity. A system may include at least two such unfolding antennas thus achieving even greater operational effectiveness regarding beam steerability and interference suppression. To prevent chaotic unfolding of the antenna, additional measures are used to prevent unwinding of inner layers of the roll before the outer layer is extended.

### BRIEF DESCRIPTION OF THE DRAWINGS

The following are the drawings for explanation of the invention:

FIG. 1: An example of how an antenna is rolled up on an antenna support in the satellite camera;

FIG. 2: An example of attachment of antenna roll-up support to the satellite;

FIG. 3: A guiding element for deflection of unfolding antenna strip members;

FIG. 4: a single phased array antenna in unfolded state;

FIG. 5-8 presents examples of attachment methods of monopole electric vibrators of a phased array antenna to the transversal antenna member;

FIGS. 9a and 9b presents an example of attachment method of monopole electric vibrators to the transversal antenna member via an insulator and a hinging element and wiring to the signal transmission line respectively from side and from above;

FIG. 10: An example of a phased array antenna system.

### DETAILED DESCRIPTION OF THE INVENTION

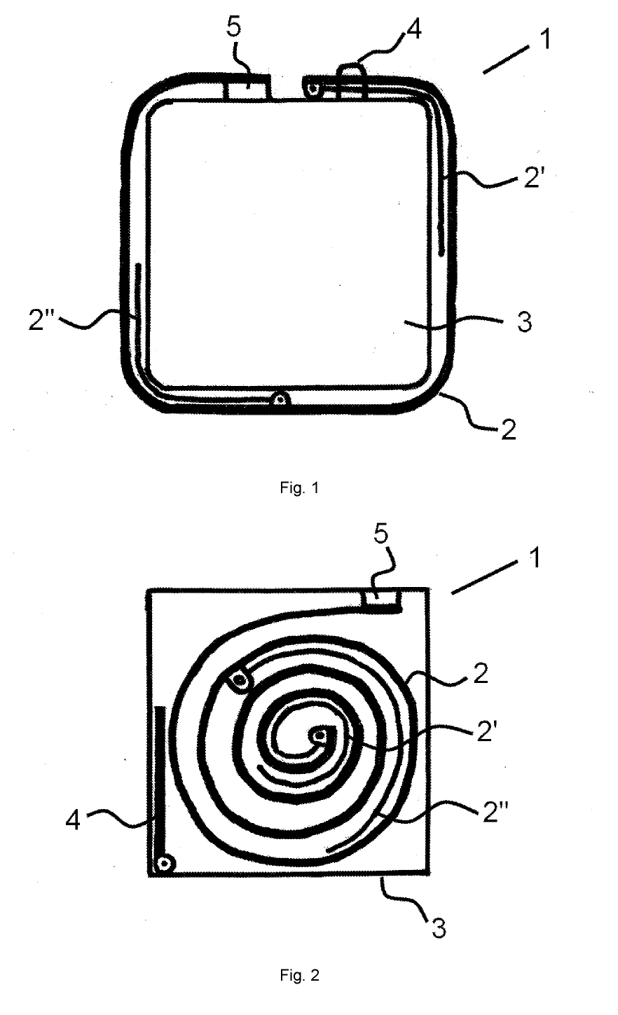

FIG. 1 and FIG. 2 presents methods of attachment of strip elements (2, 2′, 2″) of a phased array antenna (1) as designed for nanosatellites to the antenna (1) mount in the satellite chamber (3), but not limited to winding of the antenna (1) strip elements (2, 2′, 2″) around the said chamber (3), rolling of the antenna strip members (2, 2′, 2″) into a roll for placement inside the said chamber (3), and folding of the antenna strip elements (2, 2′, 2″) for placement inside chamber (3). In all cases, one end of the antenna transverse strip member (2) is fixed to the mount in the nanosatellite chamber (3) by a fixing accessory (5) and the other end is free.

The antenna (1) strip members (2, 2′, 2″) are securely held in a collapsed state occupying the least space volume and the monopole electrical vibrators (2′, 2″) and the transverse strip member (2) make an angle close to 0° at the line of attachment until the satellite reaches the intended orbit. Upon reaching the deployment location, the holding element (4) is released and the antenna stripe members (2, 2′, 2″) unroll until the antenna gains the intended shape. In the unfolded state, the antenna (1) transverse member (2) and the monopole electric vibrators (2′, 2″) make an angle larger than 0° at the line of attachment.

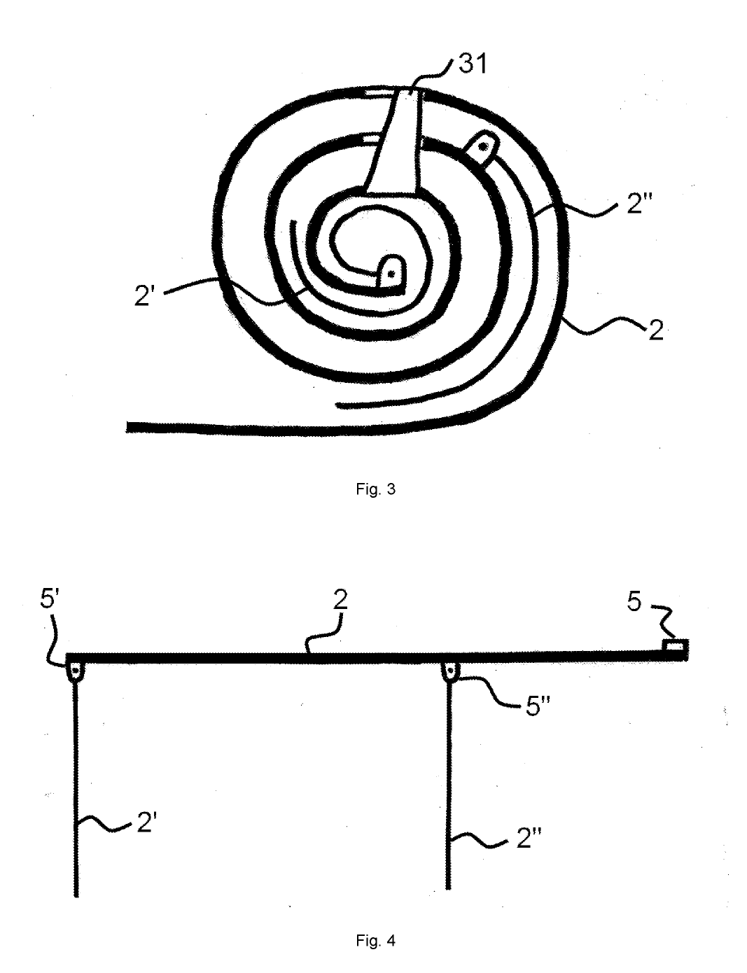

In all cases, the said antenna (1) comprises unfolding members (2, 2′, 2″) and a chamber (3) for mounting to a nanosatellite, where the said phased array antenna (1) strip elements (2, 2′, 2″) can be fastened to it, rolled upon it and subsequently released or can be placed inside the said mounting chamber (3) of a satellite. The said transverse strip members (2, 2′, 2″) comprises a transverse strip member (2) and at least one additional strip member (2′, 2″) hingedly connected to the transverse strip member (2) which forms a distinct monopole electric vibrator of the antenna (1). FIG. 3 presents an example of a guiding element (31) for unrolling of the phased array antenna (1) strip members (2, 2′, 2″). This element (31) is intended to ensure orderly unrolling of antenna strip elements (2, 2′, 2″) by preventing the inner layers to unroll before the outer layers. This element (31) is attached close to the free end of the transverse strip element, which is located in the inner part of the strip elements roller. A sticky or pasty material between the roll layers can also be used for this purpose.

FIG. 4 shows the unfolded strip part of the phased array antenna consisting of a fixing accessory (5) for attachment of the antenna (1) to the antenna (1) mount in the satellite chamber (3), a transverse strip member (2), and at least two branching monopole electric vibrators (2′, 2″). An antenna may also comprise two transverse members (2) attached to the satellite, each of which has an attached monopole electric vibrator (2′, 2″). In this case, both transverse members will unfold from the chamber (3) in opposite directions in the same way as in case of one transverse member, only in opposite directions.

At least two said branching monopole electric vibrators (2′, 2″) are fastened to the transverse strip member (2) via lightweight spring elements or lightweight articulated elements (5′, 5″) for easy unbending to essentially upright position relative to the transverse strip member (2). Although the drawing shows only two branching strip elements (2′, 2″), their number can be much larger and they can be mounted on both sides of the transverse strip member (2).

A phased array antenna (1) with two branching monopole electric vibrators (2′, 2″) can receive/transmit a circularly polarized signal or simultaneously receive/transmit two signals of different linear polarization.

All strip members (2, 2′, 2″) of the phased array antenna (1) can be made of an electrically conductive shape-memory alloy or other electrically conductive resilient material such as a steel band. The transverse strip member can be provided with additional signal conduits (91, 93), such as cables or current conducting paths. The antenna (1) of this type includes conductors of minimum size since the transverse belt element (2) performs the function of the dipole arm.

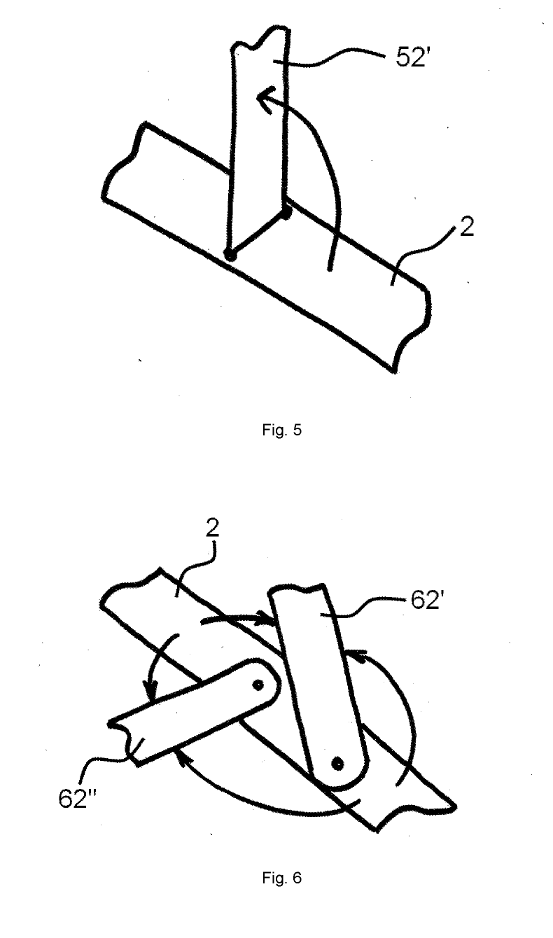

FIGS. 5-8 show some examples how monopoly electric vibrators (52′, 62′, 62″; 72′, 72″, 82′, 82″) can be attached to the transverse strip member (2) of the phased array antenna (1).

FIG. 5 shows the simplest assembly of a transverse strip member (2) of the phased array antenna (1) and a monopole electric vibrator (52′), where polarization of the phased array consisting of a transverse strip element and a monopoly vibrator (52′) is linear. The electrical vibrator (52′), the folding axis of which is parallel to the transverse strip element (52) plane, unbends after the transverse element (2) is unrolled. The planes of both members (2, 52′) in extended state are orthogonal to each other.

FIGS. 6-8 show the cases, when monopole electric vibrators (62′, 62″, 72′, 72″, 82′, 82″) are fixed to the transverse member (2) of the phased array antenna (1) in pairs next to each other. Each said vibrator (62′, 62″, 72′, 72″, 82′, 82″) in a pair has a linear polarization perpendicular to that of each other and a pair of vibrators has a circular polarization.

FIG. 6 shows monopole electric vibrators (62′, 62″), the folding axes of which are perpendicular to the plane of the transverse stripe member (2) and which unbend to 45 degrees when the transversal strip (2) is unrolled. If vibrators are not stacked upon each other in the folded state, then one vibrator (62′) tilts to 45 degrees, and the other (62″) tilts to 125 degrees. In the folded state, the planes of all three said strip elements (2, 62′, 62″) are parallel. In the unfolded state, the planes of the vibrators (62′, 62″) are parallel and perpendicular to the plane of the transverse strip member (2).

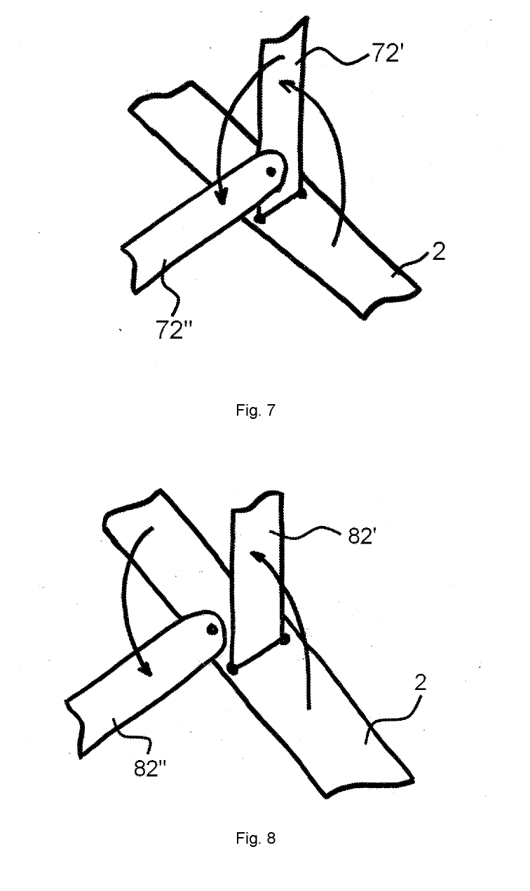

The electric vibrator (72′) in FIG. 7, the folding axis of which is perpendicular to the plane of the transverse stripe member (2), unbends to 90 degrees when the transversal strip (2) is unrolled. The electric vibrator (72″), the folding axis of which is perpendicular to the plane of the vibrator (72′), unbends to 90 degrees when the vibrator (72′) is extended. The strip elements (2, 72′, 72″) are stacked upon each other in the folded state.

FIG. 8 shows electric vibrators (82′, 82″) that unbend to 90 degrees when the transversal member (2) is unrolled. The folding axis of one electric vibrator (82″) is perpendicular to the transversal member (2) plane, and the axis of the other vibrator (82′) is parallel to the transversal member (2) plane. In the extended state, the plane of two strip members (2′, 82″) are parallel and perpendicular to the plane of the third strip member (82′).

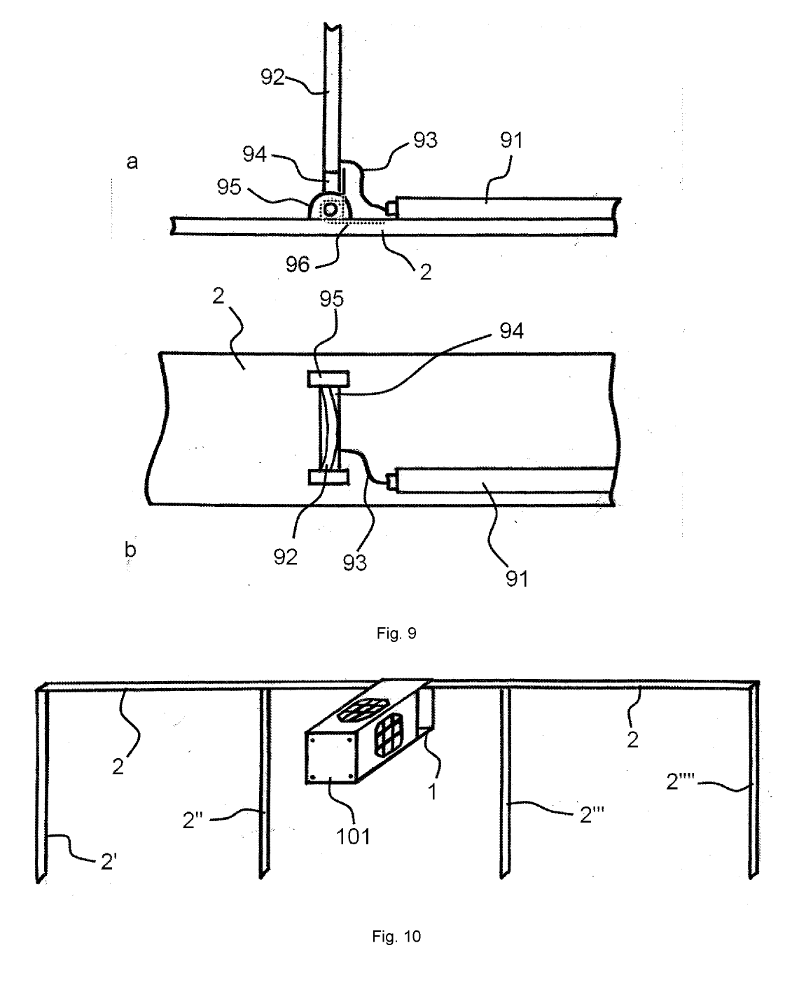

FIGS. 9a and 9b present an example, where at least one monopoly electric vibrator (92′) of the phased array antenna (1) is attached to the transversal strip member (2) via an electrically insulating element (94) and means (96) facilitating extension of the said monopole vibrator (92′), such as a spring element. Additionally, at least one monopole vibrator of the antenna can be connected to the spacecraft signal receiver/transmitter via signal conduits (91, 93), such as cables, or electrical current conducting paths.

FIG. 10 shows an example, where a system is constructed from phased array antennas (1) and consists of at least two transversal strip elements (2), which extend from the chamber (3) for mounting to the spacecraft (101) and to which the monopole electric vibrators (2′, 2″, 2′″, 2″″) are attached. A satellite (101) may have more than two phased array antennas (1), depending on the structure of the satellite itself.

Compared with conventional deployable nanosatellite monopole antennas, a phased array antenna according to the invention has a narrower field of view, higher gain factor, and ability to steer the beam by changing the signal phases of individual antenna elements.

1. Self-deploying antenna for spacecraft, comprising of a transversal member (2), attached to the chamber (3), which mounts the antenna (1) to the spacecraft, and at least one monopole electric vibrator (2′, 2″, 2′″, 2″″, 52′, 62′, 62″, 72′, 72″, 82′, 82″, 92) attached to the said transversal member (2), wherein
the transversal member (2) of the antenna (1) and at least one unbending monopole electric vibrator (2′, 2″, 2′″, 2″″, 52″, 62′, 62″, 72′, 72″, 82′, 82″, 92) are temporarily deformed so that the joint angle between the transversal member (2) and at least one monopole electric vibrator (2′, 2″, 2′″, 2″″, 52″, 62′, 62″, 72′, 72″, 82′, 82″, 92) is close to zero,
and wherein in that the joint angle between the transversal member (2) and at least one monopole electric vibrator (2′, 2″, 2′″, 2″″, 52″, 62′, 62″, 72′, 72″, 82′, 82″, 92) in the extended antenna (1) state is greater than zero.

2. An antenna (1) in accordance with claim 1, wherein the transverse member (2) of the antenna (1) is attached by a fixing accessory (5) to the antenna mount on the satellite camera (3) on one end, and is free at the other end, so that the antenna (1) may unroll and deploy after the retention element (4) holding the antenna (1) in the collapsed state is released.

3. An antenna (1) in accordance with claim 2, wherein the antenna (1) in the transportation state is rolled up into a strip roll inside the mount camera (3) of a satellite.

4. An antenna (1) in accordance with claim 3, wherein the antenna (1) in the transportation state includes a guiding element (31) for unrolling of the antenna (1).

5. An antenna (1) in accordance with claim 2, wherein the antenna (1) in the transportation state is rolled up around at least a part of the mounting chamber (3) of a satellite.

6. An antenna (1) in accordance with claim 1, wherein the said transverse member (2) and at least one monopole electric vibrator (2′, 2″, 2′″, 2′″, 52′, 62′, 62″, 72′, 72″, 82′, 82″, 92) are made of a self-straightening metal strip.

7. An antenna (1) in accordance with claim 1, wherein the monopole electric vibrators (62′, 62″), which are attached to the transverse member (2), unbend in different directions.

8. An antenna (1) in accordance with claim 1, wherein a member (72″), which is attached to a monopole electric vibrator (72′) of the transverse member (2), unbends at an angle to the said monopole vibrator.

9. An antenna (1) in accordance with claim 1, wherein the monopole electric vibrators (82′, 82″), which are attached to the transverse member (2), unbend into different planes.

10. An antenna (1) in accordance with claim 1, wherein at least one said monopole electric vibrator (92′) is attached to the transverse member (2) via an electrically insulating element (94).

11. An antenna (1) in accordance with claim 1, wherein at least one monopole electric vibrator (92′) from potentially a multitude is connected to the transmission line (91) by an electric link (93).

12. An antenna (1) in accordance with claim 1, wherein tilting of at least one said monopole electric vibrator (2′, 2″, 2′″, 2″″, 52′, 62′, 62″, 72′, 72″, 82′, 82″, 92) is controlled by a hinge element (96).

13. A self-deploying antenna system for spacecraft (101) wherein the system is a phased array antenna system, comprising a multitude of antennas (1) in accordance with claim 1.

14. An antenna (1) in accordance with claim 2, wherein the said transverse member (2) and at least one monopole electric vibrator (2′, 2″, 2′″, 2″″, 52′, 62′, 62″, 72′, 72″, 82′, 82″, 92) are made of a self-straightening metal strip.

15. An antenna (1) in accordance with claim 3, wherein the said transverse member (2) and at least one monopole electric vibrator (2′, 2″, 2′″, 2″″, 52′, 62′, 62″, 72′, 72″, 82′, 82″, 92) are made of a self-straightening metal strip.

16. An antenna (1) in accordance with claim 4, wherein the said transverse member (2) and at least one monopole electric vibrator (2′, 2″, 2′″, 2″″, 52′, 62′, 62″, 72′, 72″, 82′, 82″, 92) are made of a self-straightening metal strip.

17. An antenna (1) in accordance with claim 5, wherein the said transverse member (2) and at least one monopole electric vibrator (2′, 2″, 2′″, 2″″, 52′, 62′, 62″, 72′, 72″, 82′, 82″, 92) are made of a self-straightening metal strip.

18. An antenna (1) in accordance with claim 2, wherein the monopole electric vibrators (62′, 62″), which are attached to the transverse member (2), unbend in different directions.

19. An antenna (1) in accordance with claim 3, wherein the monopole electric vibrators (62′, 62″), which are attached to the transverse member (2), unbend in different directions.

20. An antenna (1) in accordance with claim 4, wherein the monopole electric vibrators (62′, 62″), which are attached to the transverse member (2), unbend in different directions.
